(19) United States
(12) Patent Application Publication
(10) Pub. No.: US 2020/0065438 A1
(43) Pub. Date: Feb. 27, 2020

(54) A METHOD FOR TRACKING STRUCTURAL MODAL PARAMETERS IN REAL TIME

(71) Applicant: Dalian University of Technology, Dalian, Liaoning (CN)

(72) Inventors: Tinghua YI, Dalian, Liaoning (CN); Xiaomei YANG, Dalian, Liaoning (CN); Chunxu QU, Dalian, Liaoning (CN); Hongnan LI, Dalian, Liaoning (CN)

(21) Appl. No.: 16/342,929

(22) PCT Filed: Mar. 27, 2018
(86) PCT No.: PCT/CN2018/080581

§ 371 Date: Apr. 17, 2019

(30) Foreign Application Priority Data
Feb. 24, 2018 (CN) 201810156694.6

(51) Int. Cl. G06F 17/50; G06F 17/16; G06F 17/15; G01M 5/00

(52) U.S. Cl. CPC G06F 17/5009; G06F 17/16; G06F 2217/16; G01M 5/0008; G01M 5/0066; G06F 17/15

(57) ABSTRACT

Structural health monitoring relating to a real-time tracking method for structural modal parameters. The Natural Excitation Technique transforms structural random responses into free decaying responses used to calculate structural modal parameters by the Eigensystem Realization Algorithm combined with the stabilization diagram. Considering influence of environmental excitation level on the number of identified modes, the reference mode list is formed by union of modes obtained from response sets in a day. Then the modes can be tracked automatically according to rules of minimum frequency difference and maximum Modal Assurance Criterion (MAC). To avoid mode mismatch problem caused by absence of threshold, frequency differences and MACs between all modes from the latter response set and all reference modes are calculated and the mode will be tracked into the cluster corresponding to the specified reference mode only in the case that their frequency difference is smallest and the MAC is largest.

### TECHNICAL FIELD

The presented invention belongs to the field of structural health monitoring, and relates to a real-time tracking method for structural modal parameters.

### BACKGROUND

The long-term service performance of the structure can be reflected by the variation of structural modal parameters. Modal parameter identification methods such as the Least-Square Complex Frequency domain method, the Frequency Domain Decomposition method, the Stochastic Subspace Identification method and the Eigensystem Realization Algorithm have been widely used in the field of structural modal identification. In these methods, long term structural responses are divided into many response sets according to the time. Each response set is used to calculate modal parameters respectively. Thus the modal parameters in different response sets are obtained. However, the number of modes obtained in each response set is almost impossible to be equal due to the influence of excitation level, environmental interference and stability of the algorithm. The purpose of modal tracking is to group structural modes with the same characteristics identified in different response sets into the same cluster, avoiding the phenomenon of “modal mismatching”. The previous modal tracking methods are mainly divided into three categories: 1) Manual analysis: users decide empirically whether the modal parameters identified from different response sets belong to the same cluster. Lots of effort will be wasted in this time-consuming method. 2) Threshold method: the tracking result depends on the tolerance limits of the modal parameter differences, which can be empirical constants or adaptive adjustment values. Some modes will be misclassified due to unreasonable thresholds. 3) Prediction-correction method: predict the modal parameters of the latter response sets based on perturbation theory, and then compare the predicted modal parameters with the identified modal parameters. This method is difficult to be applied in practical large-scale engineering structures because of its low computational efficiency and imperfect prediction results. Therefore, accurate modal tracking without human analysis is of great engineering significance.

### SUMMARY

The objective of the presented invention is to provide an automatic modal tracking method, which can solve the problems that unreasonable modal tracking results caused by setting threshold in practical engineering and time-consuming tracking process caused by human participation.

An automatic process for real-time tracking of structural modal parameters is proposed. First, the Natural Excitation Technique is used to transform the ambient vibration responses into the free decaying responses. Then the Eigensystem Realization Algorithm combined with the stabilization diagram is adopted to estimate modal parameters from different free decaying response sets. Subsequently, the reference mode list is formed by the union of modes obtained from the response sets in a day. Finally, the modal parameters identified by the latter response set are divided into the specified reference mode cluster according to the rules of the minimum frequency difference and the maximum Modal Assurance Criterion (MAC).

The technical solution of the present invention is as follows:

The procedures of the automated modal tracking are as follows:

Step 1: Extraction of Modal Parameters from Different Response Sets

(1) Select the response set h as y(t)=[y₁(t), y₂(t), . . . , y_{z}(t)]^{T}, t=1, 2, . . . , N, where N is the number of sampling points, z is the number of sensors to measure responses. Transform the response set h into the correlation function matrices r(τ) with various time delays τ by the Natural Excitation Technique

$$r ( τ ) = [ \begin{matrix}{r}_{1 , 1} ( τ ) & {r}_{1 , 2} ( τ ) & … & {r}_{1 , z} ( τ ) \\ {r}_{2 , 1} ( τ ) & {r}_{2 , 2} ( τ ) & … & {r}_{2 , z} ( τ ) \\ ⋮ & ⋮ & ⋱ & ⋮ \\ {r}_{z , 1} ( τ ) & {r}_{z , 2} ( τ ) & … & {r}_{z , z} ( τ )\end{matrix} ] = E [ y ( t + τ ) {y ( t )}^{T} ] \qquad ( 1 )$$

where rᵢⱼ(τ) represents the cross correlation function between the response of measurement channel i and the response of measurement channel j.

(2) Construct the block Hankel matrices Hₘₛ(k−1) and Hₘₛ(k) with the correlation function matrix r(τ) as

$${H}_{m s} ( k - 1 ) = ( \begin{matrix}r ( k ) & r ( k + 1 ) & … & r ( k + s - 1 ) \\ r ( k + 1 ) & r ( k + 2 ) & … & r ( k + s ) \\ … & … & … & … \\ r ( k + m - 1 ) & r ( k + m ) & … & r ( m + s + k - 2 )\end{matrix} ) \qquad ( 2 )$$

(3) Set k=1, and then the Eigensystem Realization Algorithm is implemented on the matrices Hₘₛ (k−1) and Hₘₛ (k) to calculate the modal parameters (frequencies, damping ratios and mode shapes) from the model orders ranging from δ to nᵤδ with the increment of δ, where δ is an even number.

(4) Preset the threshold of the frequency difference Δ_{f,lim}, the threshold of the damping difference Δ_{ξ,lim} and the MAC threshold Δ_{MAC,lim} respectively. Modes with their modal parameter dissimilarity satisfies the conditions (df≤Δ_{f,lim}, dξ≤Δ_{ξ,lim} and MAC≥Δ_{MAC,lim}) are considered as stable modes. Then stable modes at successive model orders will be grouped into one cluster if their frequency difference is less than Δ_{f,lim} and the MAC exceeds Δ_{MAC,lim}. The clusters with their sizes (the number of stable modes in a cluster) outnumber the limit nₜₒₗ are selected as physical clusters. The averages of modal parameters in each physical cluster are defined as the representative values of physical modes, and then the representative values corresponding to α physical clusters are considered as the identified modal parameters from the response set h, where the identified frequencies are f_{1,h}, f_{2,h}, . . . , f_{α,h}, the identified mode shapes are φ_{1,h}, φ_{2,h}, . . . , φ_{α,h}.

Step 2: Tracking Modal Parameters Identified from Different Response Sets.

(5) Designate the union of the structural physical modes calculated from each response set in a day as the reference mode list, where the reference frequencies are marked as f_{1,ref}, f_{2,ref}, . . . , f_{β,ref} and the reference mode shapes are φ_{1,ref}, φ_{2,ref}, . . . , φ_{β,ref}.

(6) Track the structural physical mode j from the response set h into the cluster containing the reference mode χ if their dissimilarity of modal parameters satisfies the following four formulas:

$$\begin{matrix}\frac{\vert {f}_{χ , ref} - {f}_{j , h} \vert}{max ( {f}_{χ , ref} , {f}_{j , h} )} \leq \frac{\vert {f}_{i , ref} - {f}_{j , h} \vert}{max ( {f}_{i , ref} , {f}_{j , h} )} \\ i = 1 , 2 , … , β & ( 3 ) \\ \frac{\vert {f}_{χ , ref} - {f}_{j , h} \vert}{max ( {f}_{χ , ref} , {f}_{j , h} )} \leq \frac{\vert {f}_{χ , ref} - {f}_{k , h} \vert}{max ( {f}_{χ , ref} , {f}_{k , h} )} \\ k = 1 , 2 , … , α & ( 4 ) \\ MAC ( {ϕ}_{χ , ref} , {ϕ}_{j , h} ) \geq MAC ( {ϕ}_{i , ref} , {ϕ}_{j , h} ) \\ i = 1 , 2 , … , β & ( 5 ) \\ MAC ( {ϕ}_{χ , ref} , {ϕ}_{j , h} ) \geq MAC ( {ϕ}_{χ , ref} , {ϕ}_{k , h} ) \\ k = 1 , 2 , … , α & ( 6 )\end{matrix}$$

The advantage of the invention is that the structural physical modes identified from the latter response set can be tracked automatically according to the rules of the minimum frequency difference and the maximum MAC between all reference modes and all modes from the latter response set. This automated method can effectively avoid the problems of time-consuming due to manual participation and mode missing caused by setting thresholds.

### DESCRIPTION OF DRAWINGS

FIG. 1 presents the layout of fourteen vertical acceleration sensors of a bridge.

FIG. 2 shows the automatic tracking results according to this invention.

FIG. 3 shows the tracking results according to the threshold method.

### DETAILED DESCRIPTION

The present invention is further described below in combination with the technical solution.

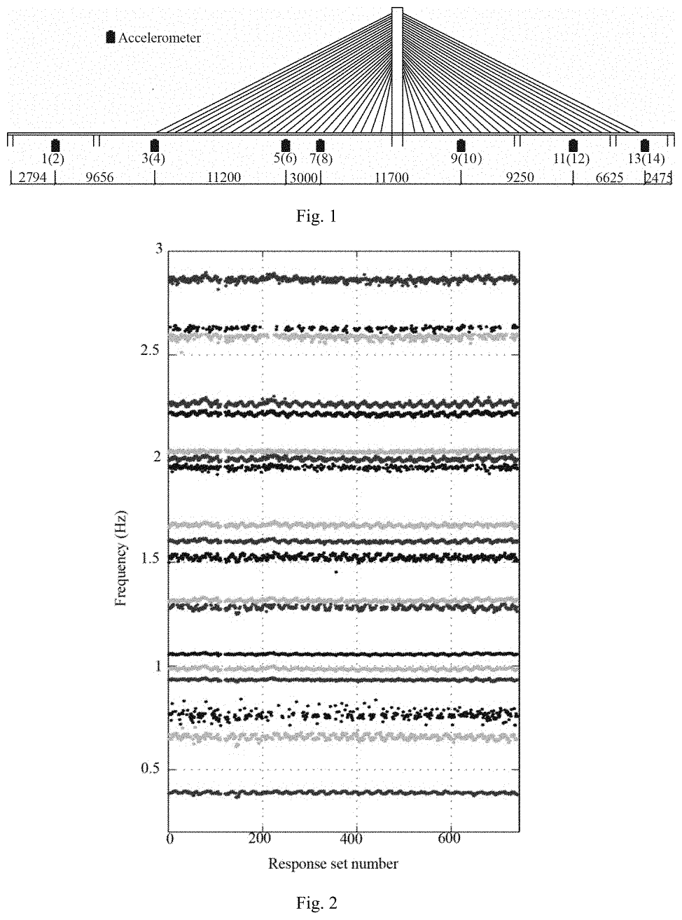

The bridge analyzed in the example is a single tower double cable plane asymmetric prestressed concrete cable-stayed bridge. As shown in FIG. 1, fourteen vertical acceleration sensors are arranged on the main girder to monitor the dynamic characteristics of the bridge. The vertical acceleration responses under ambient excitation are collected from Aug. 1, 2016 to Aug. 31, 2016, with the sampling frequency of 100 Hz. One hour responses from fourteen sensors are selected as a response set to estimate modal parameters.

The procedures are described as follows:

(1) The structural responses collected from 0:00-1:00 in Aug. 1, 2016 are selected as the response set h=1. The Natural Excitation Technique is used to transform the response set y(t)=[y₁(t), y₂(t), . . . , y₁₄(t)]^{T}, t=1, 2, . . . , N into the correlation function matrices with various time delays τ, as shown in Eq (1).

(2) Set m=200, s=200. The correlation function matrices r(τ) with τ=1˜399 and τ=2˜400 are used to build the block Hankel matrices Hₘₛ(0) and Hₘₛ (1), as shown in Eq. (2).

(3) Set the model orders range from δ=4 to nᵤδ=280, with the order increment of δ=4 and the order number of nᵤ=70. Then the modal parameters (system eigenvalues λᵢ, natural frequencies fᵢ, damping ratios ξᵢ and mode shapes φᵢ) in each model order are calculated through the Eigensystem Realization Algorithm.

(4) The threshold of the frequency difference, the threshold of the damping difference and the MAC threshold are set as Δ_{f,lim}=5%, Δ_{ξ,lim}=20% and Δ_{MAC,lim}=90% respectively. Modes with their modal parameter dissimilarity satisfies the conditions (df≤Δ_{f,lim}, dξ≤Δ_{ξ,lim} and MAC≥Δ_{MAC,lim}) are stable. Then stable modes at successive model orders are grouped into one cluster if their frequency difference is less than Δ_{f,lim} and the MAC exceeds Δ_{MAC,lim}. The clusters with their sizes (the number of stable modes in a cluster) outnumber the limit nₜₒₗ=0.5nᵤ are selected as physical clusters. The averages of modal parameters in each physical cluster are defined as the representative values of physical modes, and then the representative values corresponding to α=18 physical clusters are considered as the identified modal parameters from the response set h, where the identified frequencies are f_{1,1}=0.378 Hz, f_{2,1}=0.642 Hz, f_{3,1}=0.750 Hz, f_{4,1}=0.937 Hz, f_{5,1}=0.998 Hz, f_{6,1}=1.066 Hz, f_{7,1}=1.266 Hz, f_{8,1}=1.336 Hz, f_{9,1}=1.519 Hz, f_{10,1}=1.618 Hz, f_{11,1}=1.692 Hz, f_{12,1}=1.946 Hz, f_{13,1}=2.018 Hz, f_{14,1}=2.050 Hz, f_{15,1}=2.245 Hz, f_{16,1}=2.297 Hz, f_{17,1}=2.586 Hz, f_{18,1}=2.884 Hz.

(5) The union of the structural physical modes calculated from each response set in Aug. 1, 2016 is designated as the reference mode list, where the reference frequencies are f_{1,ref}=0.378 Hz, f_{2,ref}=0.642 Hz, f_{3,ref}=0.750 Hz, f_{4,ref}=0.937 Hz, f_{5,ref}=0.998 Hz, f_{6,ref}=1.066 Hz, f_{7,ref}=1.266 Hz, f_{8,ref}=1.336 Hz, f_{9,ref}=1.519 Hz, f_{10,ref}=1.618 Hz, f_{11,ref}=1.692 Hz, f_{12,ref}=1.946 Hz, f_{13,ref}=2.018 Hz, f_{14,ref}=2.050 Hz, f_{15,ref}=2.245 Hz, f_{16,ref}=2.297 Hz, f_{17,ref}=2.586 Hz, f_{18,ref}=2.884 Hz.

(6) The structural physical mode j from the response set h will be tracked into the cluster containing the reference mode χ if their dissimilarity of modal parameters satisfies Eqs (3-6). The tracking results are shown in FIG. 2.

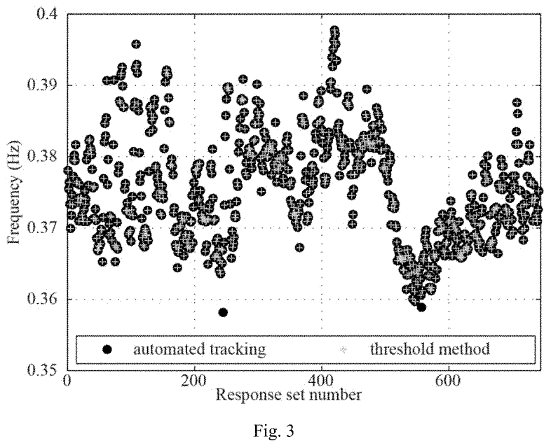

To illustrate the superiority of the proposed method, the traditional threshold method is used to track the first modes changing with time, where the relative frequency difference and the MAC should satisfy |f_{χ,ref}−f_{j,h}|/max(f_{χ,ref}, f_{j,h})≤5% and MAC (φ_{χ,ref},φ_{j,h})≥90% respectively. As shown in the crosses in FIG. 3, some modes cannot be tracked since the modal parameter differences between these modes and the reference modes do not meet |f_{χ,ref}−f_{j,h}|/max(f_{χ,ref}, f_{j,h})≤5% and MAC (φ_{χ,ref},φ_{j,h})≥90%.

We claim:

1. A method for tracking structural modal parameters in real time, wherein:
step 1: extraction of modal parameters from different response sets
(1) select a response set h as y(t)=[y₁(t), y₂(t), . . . , y_{z}(t)]^{T}, t=1, 2, . . . , N, where N is number of sampling points, z is number of sensors to measure responses; transform the response set h into correlation function matrices r(τ) with various time delays τ by Natural Excitation Technique:
$$r ( τ ) = [ \begin{matrix}{r}_{1 , 1} ( τ ) & {r}_{1 , 2} ( τ ) & … & {r}_{1 , z} ( τ ) \\ {r}_{2 , 1} ( τ ) & {r}_{2 , 2} ( τ ) & … & {r}_{2 , z} ( τ ) \\ ⋮ & ⋮ & ⋱ & ⋮ \\ {r}_{z , 1} ( τ ) & {r}_{z , 2} ( τ ) & … & {r}_{z , z} ( τ )\end{matrix} ] = E [ y ( t + τ ) {y ( t )}^{T} ] \qquad ( 1 )$$
where rᵢⱼ(τ) represents cross correlation function between response of measurement channel i and the response of measurement channel j;
(2) construct block Hankel matrices Hₘₛ(k−1) and Hₘₛ(k) with a correlation function matrix r(τ) as
$${H}_{m s} ( k - 1 ) = ( \begin{matrix}r ( k ) & r ( k + 1 ) & … & r ( k + s - 1 ) \\ r ( k + 1 ) & r ( k + 2 ) & … & r ( k + s ) \\ … & … & … & … \\ r ( k + m - 1 ) & r ( k + m ) & … & r ( m + s + k - 2 )\end{matrix} ) \qquad ( 2 )$$
(3) set k=1, and then the Eigensystem Realization Algorithm is implemented on the matrices Hₘₛ (k−1) and Hₘₛ (k) to calculate the modal parameters (frequencies, damping ratios and mode shapes) from the model orders ranging from δ to nᵤδ with the increment of δ, where δ is an even number;
(4) preset the threshold of the frequency difference Δ_{f,lim}, the threshold of the damping difference Δ_{ξ,lim} and the MAC threshold Δ_{MAC,lim} respectively; modes with their modal parameter dissimilarity satisfies the conditions df≤Δ_{f,lim}, dξ≤Δ_{ξ,lim} and MAC≥Δ_{MAC,lim}, are considered as stable modes; then stable modes at successive model orders will be grouped into one cluster if their frequency difference is less than Δ_{f,lim} and the MAC exceeds Δ_{MAC,lim}; the clusters with their sizes of the number of stable modes in a cluster outnumber the limit nₜₒₗ are selected as physical clusters; the averages of modal parameters in each physical cluster are defined as the representative values of physical modes, and then the representative values corresponding to α physical clusters are considered as the identified modal parameters from the response set h, where the identified frequencies are f_{1,h}, f_{2,h}, . . . , f_{α,h}, the identified mode shapes are φ_{1,h}, φ_{2,h}, . . . , φ_{α,h};
step 2: tracking modal parameters identified from different response sets;
(5) designate the union of the structural physical modes calculated from each response set in a day as the reference mode list, where the reference frequencies are marked as f_{1,ref}, f_{2,ref}, . . . , f_{β,ref} and the reference mode shapes are φ_{1,ref}, φ_{2,ref}, . . . , φ_{β,ref};
(6) track the structural physical mode j from the response set h into the cluster containing the reference mode χ if their dissimilarity of modal parameters satisfies the following four formulas:
$$\begin{matrix}\frac{\vert {f}_{χ , ref} - {f}_{j , h} \vert}{max ( {f}_{χ , ref} , {f}_{j , h} )} \leq \frac{\vert {f}_{i , ref} - {f}_{j , h} \vert}{max ( {f}_{i , ref} , {f}_{j , h} )} \\ i = 1 , 2 , … , β & ( 3 ) \\ \frac{\vert {f}_{χ , ref} - {f}_{j , h} \vert}{max ( {f}_{χ , ref} , {f}_{j , h} )} \leq \frac{\vert {f}_{χ , ref} - {f}_{k , h} \vert}{max ( {f}_{χ , ref} , {f}_{k , h} )} \\ k = 1 , 2 , … , α & ( 4 ) \\ MAC ( {ϕ}_{χ , ref} , {ϕ}_{j , h} ) \geq MAC ( {ϕ}_{i , ref} , {ϕ}_{j , h} ) \\ i = 1 , 2 , … , β & ( 5 ) \\ MAC ( {ϕ}_{χ , ref} , {ϕ}_{j , h} ) \geq MAC ( {ϕ}_{χ , ref} , {ϕ}_{k , h} ) \\ k = 1 , 2 , … , α . & ( 6 )\end{matrix}$$
